(19) United States
(12) Patent Application Publication
(10) Pub. No.: US 2006/0012560 A1
(43) Pub. Date: Jan. 19, 2006

(54) Keypad for performing communication and signal transmission of internet protocol phone

(75) Inventors: Yen-Chun Wu, Shu Lin City (TW); Li-Chun Huang, Chung Ho City (TW)

Correspondence Address: BACON & THOMAS, PLLC, 625 SLATERS LANE, FOURTH FLOOR, ALEXANDRIA, VA, 22314, US

(73) Assignee: ORtek Technology, Inc., Chung Ho City (TW)

(21) Appl. No.: 10/889,107

(22) Filed: Jul. 13, 2004

(51) Int. Cl. G09G 5/00

(52) U.S. Cl. 345/156

(57) ABSTRACT

The present invention discloses a keypad for performing a communication and a signal transmission of an internet protocol phone, which comprises a housing having a control unit mounted therein. The control unit includes a keyboard module and an internet protocol phone module, which enable the keypad to receive a switch signal issued from a mode switch key mounted therein or an internet protocol phone signal issued from a remote area, and then transmit the received signal to the keyboard module and internet protocol phone module for accomplishing output of keycode and transmission of the internet protocol phone signal.

### BACKGROUND OF THE INVENTION

1. Field of the Invention

The invention relates to a key pad, more particularly to a keypad capable of being switched between a symbol input mode and an internet protocol phone operation mode and utilizing key sets disposed on the key pad for accomplishing instruction input of number, arrow, operator, or function or operation of phone-dialing, phone-connecting, phone-disconnecting, or increasing/decreasing volume of the sound produced by the audio emitter.

2. Prior Art

Generally speaking, several items, for example, a telephone, a computer monitor, documents, a keyboard, a mouse, or combination thereof, are usually disposed on an ordinary office desk. In some locations, however, a number key region, an arrow key region, or a function key region located on the right side of an ordinary keyboard may be merely required by the user, if the user just needs equipment for inputting numbers or moving a cursor. Accordingly, a small-scale input equipment, as shown in FIG. 1, referred to as keypad 1 with small volume is utilized to replace with the number key region, the arrow key region, or the function key region located on the right side of the main keyboard, as shown in FIG. 3, to avoid it occupying much more space.

In addition, the present mainstream telephone system is operated through the public switched telephone network (abbreviated as PSTN), in which various circuit-switching operations are operated through a telephone and telegraph office or a telecommunication company. When the line is put through, the link of the communication between the calling party and the called party is equal to a leased-line. Accordingly, the calling party is demanded to pay the phone bill according to the distance between them. If it is transnational communication, the charge for it will be incredible. Moreover, in order to process an audio, a video, or other data of a company, the respective network must be disposed for performing the transmission. However, various networks have different transmitting requirements, which will result in higher costs for installation, maintenance, and re-configuration. Furthermore, software schemes of various networks are really different from their hardware schemes. So, it is very difficult to integrate with these networks. Their potential purposes are therefore limited.

Nevertheless, following the recently developing of the internet network, broadband internets are continually constructed worldwide. As a developing technique, various internet protocols (IP) are utilized by people for processing the audio, the video, or the other data. And, the audio, the video, or the other data are real-time transmitted on the internet in data packet forms.

In addition, the audio transmitting technique of the internet is composed of internet protocol phone, voice over internet protocol (abbreviated as VoIP), and several VoIP gateways, so that the received audio sent by the calling party can be digitalized and compressed by the VoIP, and then transmitted to the internet protocol phone, internet equipment and so forth of the called party in a packet form. After it is reverse operated by the VoIP, the sound produced by the calling party can be heard so as to perform the communication function. Therefore, it is not necessary for the user to perform the long-distance conversation through the conventional PSTN and much money can be saved for this reason.

If the company desires to change the conventional telephone into the internet protocol phone, however, the internet protocol phone, the computer monitor, the computer host, documents, the keyboard, the keypad, or the mouse are still disposed on the desk. The changing from the conventional phone into the internet protocol phone does not vacate any space. For the user who requires a large-area desk it is indeed a perplexed matter. Accordingly, it is believed that this problem can be solved by combining the internet protocol phone with an electronic equipment, for example, a keyboard, which must be disposed on the desk for use.

### SUMMARY OF THE INVENTION

Whereas the above deficiencies of prior art, the inventor had made long-term researches and experiments to finally develop a keypad for performing a communication and a signal transmission of an internet protocol phone in accordance with the present invention.

According to one aspect of the present invention, a keypad for performing a communication and a signal transmission of an internet protocol phone is provided. The keypad comprises a housing having a control unit therein. The control unit includes a keyboard module so as to enable the control unit to use the keyboard module to process keycode signal received by the keypad. The control unit further includes an internet protocol phone module so that the control unit is enabled to apply the internet protocol phone module to process the internet protocol phone signal received by the keypad. In addition, a connecting port connecting to an electronic equipment, for example, a computer host, is mounted on the housing, wherein the connecting port is also connected to the control unit so that the signal can be transmitted between the keypad and the electronic equipment. Moreover, an audio receiver, for example, a microphone, is mounted on one terminal of the housing. An audio emitter, for example, a speaker, is mounted on another terminal of the housing. The audio receiver and the audio emitter are connected to a codec mounted in the housing respectively, wherein the codec is further connected to the control unit so that the internet protocol phone signal processed by the control unit is then decoded by the codec. The decoded signal is then transmitted to the audio emitter to produce sound. In addition, the sound received by the audio receiver is encoded by the codec. The encoded signal is then transmitted to the control unit to perform the subsequent processing and thereafter transmitted outwardly through the connecting port to accomplish the communication purpose.

The above and other objects, features and advantages of the present invention will become apparent from the following detailed description taken with the accompanying drawings.

### BRIEF DESCRIPTION OF THE DRAWINGS

FIG. 1 is a diagram showing the outward appearance of a keypad according to the prior art.

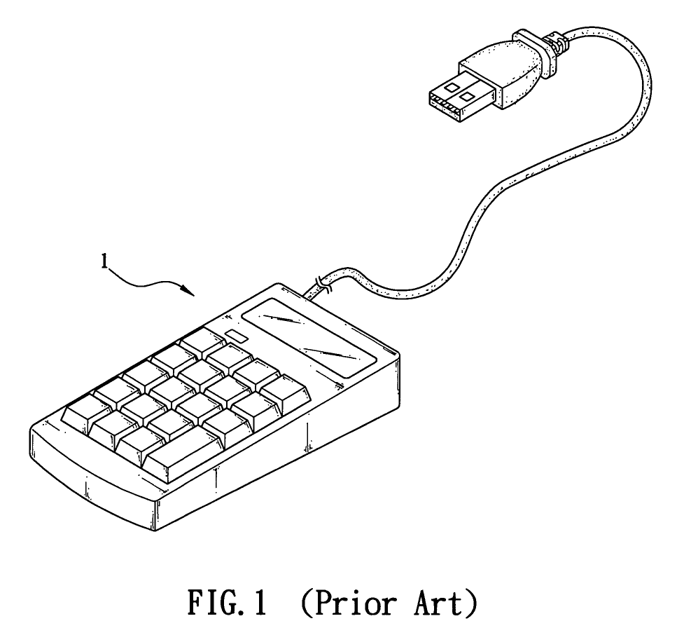

FIG. 2 is a framework diagram of the present invention.

FIG. 3 is a diagram showing the outward appearance of the present invention.

### DETAILED DESCRIPTION OF THE PREFERRED EMBODIMENT

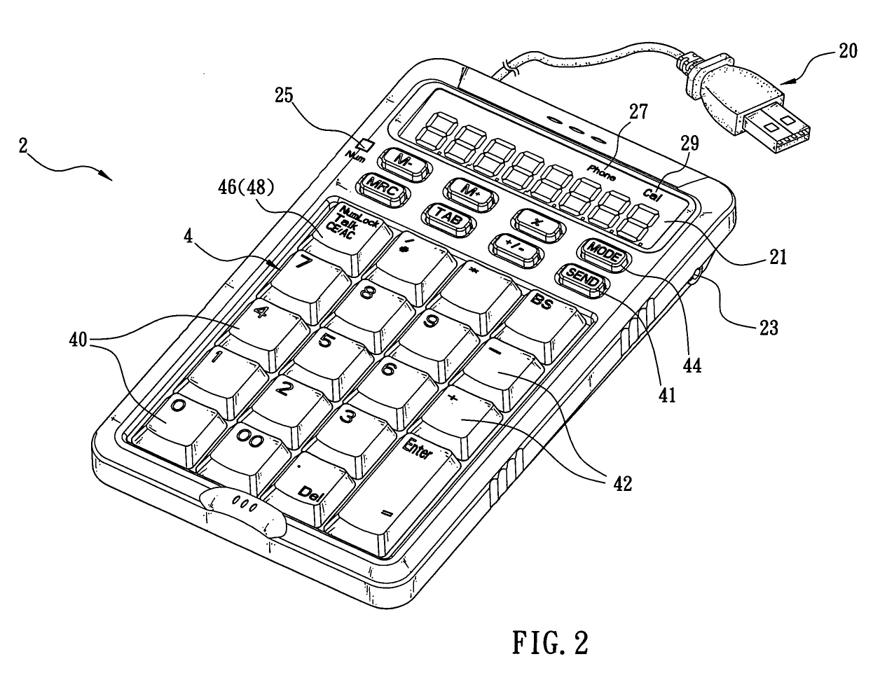

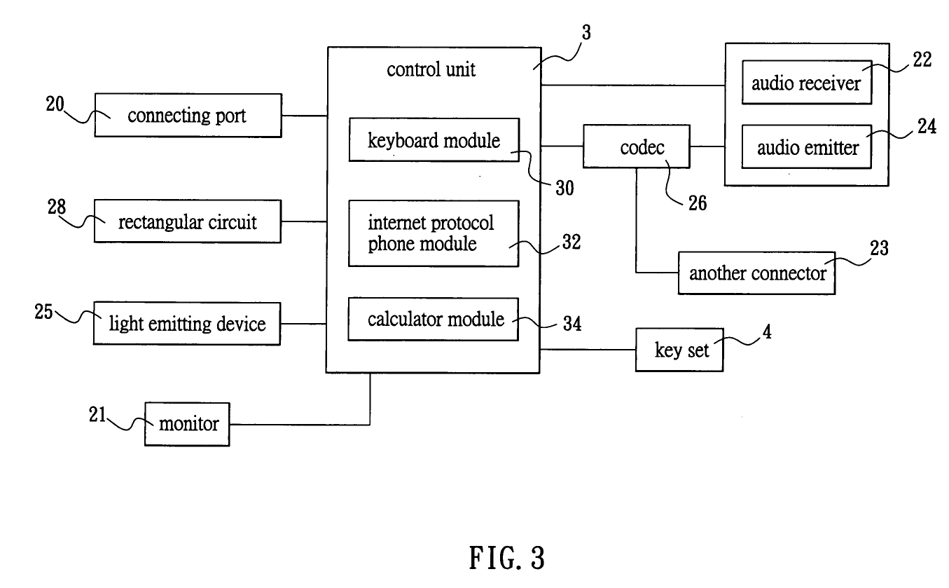

The present invention discloses a keypad for performing a communication and a signal transmission of an internet protocol phone. Please refer to FIG. 2 and FIG. 3, a housing 2 having a control unit 3 mounted therein is provided, wherein the control unit 3 is used to control and handle an electronic device connected thereto. A keyboard module 30 and an internet protocol phone module 32 are mounted in the control unit 3 so that the control unit 3 is enabled to process its received keycode signal by using the keyboard module 30. In addition, the control unit 3 is also enabled to process the received internet protocol phone signal by using the internet protocol phone module 32. Further, a connecting port 20, for example, an universal serial bus (USB), connecting to an electronic equipment, such as a computer host, is mounted on the housing 2. The connecting port 20 is also connected to the control unit 3 so that the signal can be transmitted between the key pad and the electron equipment. Moreover, an audio receiver 22, for example, a microphone, is mounted on one terminal of the housing 2. An audio emitter 24, for example, a speaker, is mounted on another terminal of the housing 2. The audio receiver 22 and the audio emitter 24 are connected respectively to a codec 26 mounted in the housing, wherein the codec 26 is further connected to the control unit 3.

Accordingly, the internet protocol phone signal transmitted from a remote site to the electronic equipment is further transmitted through the connecting port 20 to the internet protocol phone module 32 which is enable to process the internet protocol phone signal. The internet protocol phone signal is decoded by the codec 26 and then transmitted to the audio emitter 24 for producing sound. In addition, the sound received by the audio receiver 22 is encoded by the codec 26 and then transmitted to the internet protocol phone module 32 for performing the subsequent processing so that the encoded sound is transmitted to the electronic equipment through the connecting port 20 and then further transmitted to a remote receiver, for example, an internet protocol phone, through the electronic equipment.

In one preferred embodiment of the present invention, a rectangular circuit 28 connecting to the control unit 3 is mounted in the housing 2 so that the produced key pulse signal is transmitted to the keyboard module 30 for performing the subsequent processing to produce various keycode signals. Alternatively, the produced key pulse signal is transmitted to the internet protocol phone module 32 for performing the subsequent processing to produce various dialing signals. Alternatively, the produced key pulse signal is transmitted to the control unit 3 for performing the subsequent processing to produce various control signals.

In the above embodiment, a key set 4 is embedded on a surface of the housing 2 at a position corresponding to the rectangular circuit 28. The key set 4 at least comprises a plurality of number, arrow, and function keys 40, for example, 0˜9, 00 number key, and so forth, a plurality of operator keys 42, for example, +, −, ×, and ÷ operator key), a mode switch key 44, a number lock key 46, and a connecting/disconnecting key 48, wherein a portion of these keys is extended into the housing 3 so that the pressing against these keys can trigger the rectangular circuit 28 to produce the key pulse signal. The pressing against the mode switch key 44 enables the control unit 3 to produce a switch signal according to the corresponding key pulse signal produced by the rectangular circuit 28 and to switch the keypad between a symbol input mode and an internet protocol phone operation mode according to the switch signal so that the on-key pulse signal subsequently produced by the rectangular circuit 28 can be transmitted to the keyboard module 30, the internet protocol phone module 32, or the control unit 3 for performing the subsequent processing to accomplish instruction input of number, arrow, operator, or function or operation of phone-dialing, phone-connecting, phone-disconnecting, or increasing/decreasing volume of the sound produced by the audio emitter.

Thus, if the keypad is in a symbol input mode, the corresponding key pulse signal produced by the rectangular circuit 28 due to the pressing against the plurality of number, arrow and function keys 40, operator keys 42, and the number lock key 46 is transmitted to the keyboard module 30. The keyboard module 30 is therefore enabled to produce various keycode signals. These keycode signals are then transmitted to the electronic equipment through the connecting port 20 for performing processing to accomplish the instruction input of number, arrow, operator, or function. In this status, the internet protocol phone module 32 is still enabled to transmit the internet protocol phone signal to continue the communication without interfering with the operation of the keyboard module 30.

In addition, if the keypad is in an internet protocol phone operation mode, the corresponding key pulse signal produced by the rectangular circuit 28 due to the pressing against the number, arrow and function keys 40, the connecting/disconnecting key 48, or the operator keys 42, for example, an addition operation key and a subtraction operation key is transmitted to the internet protocol phone module 32. The internet protocol phone module 32 is therefore enabled to produce various dialing signals according to the key pulse signal. These dialing signals are then transmitted to the electronic equipment or other device through the connecting port 20 for performing the subsequent processing to accomplish an operation of phone-dialing, phone-connecting, phone-disconnecting, or increasing/decreasing volume of the sound produced by the audio emitter.

In order to further describe the way of processing the dialing signal by the internet protocol phone module 32 when the key pulse signal is transmitted to the internet protocol phone module 32. An operation status is illustrated as an example, after the addition operation key and the subtraction operation key are pressed respectively if the key pad is set in an internet protocol phone operation mode. The description as follows:

The pressing against the addition operation key enables a corresponding key pulse signal produced by the rectangular circuit 28 to be transmitted to the. The internet protocol phone module 32 is therefore enabled to produce a corresponding dialing signal. The corresponding dialing signal is then transmitted to the audio emitter 24 so that the audio emitter 24 is capable of increasing its volume according to the dialing signal. If the subtraction operation key is pressed, a corresponding key pulse signal produced by the rectangular circuit 28 is transmitted to the internet protocol phone module 32 which is therefore enabled to produce a corresponding dialing signal. The corresponding dialing signal is transmitted to the audio emitter 24 so that the audio emitter 24 is capable of decreasing its volume according to the dialing signal.

The internet protocol phone module 32 can receive the key pulse signal produced by the rectangular circuit 32 due to the pressing against the plurality of number, arrow and function keys 40 to produce a corresponding dialing signal. And, a telephone number set is formed by sufficient accumulation of the dialing signal. Thereafter, a phone call is made by the internet protocol phone module 32 to a remote receiver according to the telephone number set.

Moreover, when the keypad is in an off-line status, if an internet protocol phone signal is transmitted through the connecting port 20 to the control unit 3, a notifying signal will be produced by the control unit 3 according to the internet protocol phone signal. The notifying signal is then transmitted to the codec 26 for decoding and thereafter transmitted to the audio emitter 24 for producing a ring sound to inform of an incoming phone call. If the ring sound is produced by the audio emitter 24 to inform of the incoming phone call, the pressing against the connecting/disconnecting key 48 will enable the internet protocol phone module 32 to produce a corresponding dialing signal according to the received key pulse signal produced by the rectangular circuit 32 so that the internet protocol phone module 32 can process the subsequent internet protocol phone signal for communication by using the audio emitter 24 and audio receiver 22.

In this embodiment, when the keypad is in the internet protocol phone mode, the keypad can be switched between the internet protocol phone mode and the symbol input operation mode or restored automatically to the last operation mode by the control unit 3 if the control unit 3 does not receive the key pulse signal transmitted by the rectangular circuit 28 within a period of time.

In this embodiment, a monitor 21 is mounted on a readily observing position of the housing 2, the monitor 21 is connected to the control unit 3 so that the display signal produced by the control unit 3 according to the keycode signal, dialing signal, or switch signal is transmitted to the monitor 21 for showing a corresponding display on the monitor 21 according to this display signal. Thus, the user can observe a present operation status, an inputted number, or a dialing number of the keypad through the shown image.

In order to enable the keypad to show a calling party of the internet protocol phone signal which is received by this keypad, the control unit 3 can analyze the internet protocol phone signal by using the internet protocol phone module 32 for acquiring a source data of the calling party, for example, an IP address and a telephone number of the calling party. The corresponding display signal is then produced by the control unit 3 according to the source data. Thereafter, the display signal is transmitted to the monitor 21 for showing the corresponding display on the monitor 21 according to the display signal.

In this embodiment, another connector 23 is further mounted in the housing 2 for connecting to an external transceiver, the codec 26, and the control unit 3. And, in a status of connecting to the external transceiver, the another connector 23 can emit a connecting signal to the control unit 3 which is therefore enabled to transmit a stop signal to the audio emitter 24 and the audio receiver 22 for stopping the operation of the audio emitter 24 and the audio receiver 22 to produce sound and receive the sound by using the external transceiver merely.

In another preferred embodiment of the present invention, the control unit 3 further comprises a calculator module 34, which is used for producing the switch signal after the mode switch key 44 is pressed. Thus, the keypad can be switched between the symbol input operation mode, an internet protocol phone operation mode, or a calculator operation mode by the control unit 3 to enable the on-key pulse signal subsequently produced by the rectangular circuit 28 to be transmitted to the control unit, the keyboard module, the internet protocol phone module, or the calculator module respectively according to the present operation mode for performing the subsequent processing.

The corresponding key pulse signal produced by the rectangular circuit 28 due to the pressing against the number, arrow, and function keys 40, the operator key 42, and the number lock key 46 is transmitted to the calculator module 34 so that the calculator module 34 is enabled to produce various calculating signals according to various key pulse signal. The calculating signal is then transmitted to the control unit 3 by which the corresponding display signal, for example, showing of number, calculating result, etc., is produced according to the calculating signal. The display signal is then transmitted to the monitor 21 for showing a corresponding display on the monitor 21 according to the display signal.

In this embodiment, the key set 4 further comprises a send key 41. After the send key 41 is pressed, a key pulse signal is transmitted from the rectangular circuit 28 to the calculator module 34. Thus, a sending signal is produced by the calculator module 34 for transmitting a data of the display shown on the monitor 21 to the electronic equipment through the connecting port 20 to perform the subsequent processing.

In these embodiments, a light emitting device 25 is mounted on the housing 2. The rectangular circuit 28 can transmit the corresponding key pulse signal to the control unit 3 after the number lock key 46 is pressed. Thus, the control unit 3 is enabled to produce a corresponding light emitting signal. The corresponding light emitting signal is then transmitted to the light emitting device 25 for changing the light emitting status of the light emitting device 25. Therefore, the on or off status of the number key 46 can be observed by the user according to the light emitting status of the light emitting device 25.

In these embodiments, a first operation status display region 27 and a second operation status display region 29 are set on the monitor 21 for showing various symbols, for example, photo, cal, or pattern, to express the present operation mode of the keypad. After the mode switch key 44 is pressed, the keypad can be switched among the symbol input operation mode or the internet protocol phone operation mode and the calculator operation mode by the control unit 3 according to the switch signal. Meanwhile, a corresponding display signal is produced by the control unit 3 according to the switch signal. The corresponding display signal is then transmitted to the monitor 21 so that a corresponding image is shown on the first operation status display region 27 and the second operation status display region 29 of the monitor 21. Thus, the user can observe the present operation status of the keypad through the shown image.

During the communication of the keypad, in order to prevent the communication from disconnecting because of mis-touching the internet protocol phone signal 20. In these embodiments, if the internet protocol phone module 32 is proceeding, the connecting/disconnecting key 44 must be continuously pressed for a period of time so that the rectangular circuit 28 can transmit the key pulse signal continuously to the internet protocol phone module 32 within a predetermined period of time. The internet protocol phone module 32 is therefore capable of producing a corresponding dialing signal to disconnect the subsequent internet protocol phone signal for stopping the communication.

As mentioned above, the keypad of the present invention is to combine the conventional keypad with the internet protocol phone so that the keypad can be in a convention keypad operation mode or internet protocol phone operation mode. In addition, by combining with a conventional calculator, the keypad further includes a calculator operation mode. In these operation modes, the key set mounted on the keypad can be used directly to accomplish instruction input of number, arrow, operator, or function and operation of phone-dialing, phone-connecting, phone-disconnecting, or increasing/decreasing volume of the sound produced by the audio emitter. Accordingly, the space-occupation problem of disposing without combining with the keypad, internet protocol phone, and calculator is resolved. And, it is simple and easy to use for the user.

While the invention has been described by means of specific embodiments, numerous modifications and variations could be made thereto by those skilled in the art without departing from the scope and spirit of the invention set forth in the claims.

What the invention claimed is:

1. A keypad for performing a communication and a signal transmission of an internet protocol phone, comprising:
a housing;
a control unit mounted in the housing for controlling and handling an electronic device to which the control unit is connected;
a keyboard module mounted in the control unit so that the control unit is enabled to process a received keycode signal by the keyboard module;
an internet protocol phone module mounted in the control unit so that the control unit is enabled to process the received internet protocol phone signal by the internet protocol phone module;
a connecting port mounted on the housing and connected to the control unit for connecting to the keypad and an electronic equipment through the connecting port;
an audio receiver mounted on one terminal of the housing;
an audio emitter mounted on the other terminal of the housing;
a codec mounted in the housing and connected to the control unit so that the control unit is enabled to transmit the internet protocol phone signal, which is processed by the control unit and then decoded by the codec, to the audio emitter for producing sound, and the sound received by the audio receiver and then encoded by the codec is transmitted to the control unit for performing the subsequent processing and thereafter transmitted outwardly through the connecting port;
a key set mounted on the housing in a position between the audio receiver and the audio emitter; and
a rectangular circuit mounted in the housing in a position corresponding to the key set so that a key of the key set can touch the rectangular circuit after the key is pressed to produce a key pulse signal which is then transmitted to the control unit for performing the subsequent processing.

2. The keypad of claim 1, wherein the key set comprises a plurality of number, arrow and function keys, a plurality of operator keys, a mode switch key, a number lock key, and a connecting/disconnecting key, wherein a portion of these keys is extended into the housing so that the rectangular circuit is triggered by pressing against these keys to produce the key pulse signal.

3. The keypad of claim 2, wherein the control unit is enabled by pressing against the mode switch key to produce a switch signal according to the corresponding key pulse signal produced by the rectangular circuit, and to switch the keypad between a symbol input mode and an internet protocol phone operation mode according to the switch signal so that the on-key pulse signal subsequently produced can be transmitted to the keyboard module, the internet protocol phone module, or the control unit according to the present operation mode for performing the subsequent processing.

4. The keypad of claim 2, wherein if the keypad is in a symbol input mode, the control unit can produce various keycode signals by using the keyboard module according to the corresponding key pulse signal produced by the rectangular circuit due to the pressing against the plurality of number, arrow and function keys, the plurality of operator keys, and the number lock key.

5. The keypad of claim 2, wherein if the keypad is in an internet protocol phone operation mode, the control unit can produce various dialing signals through the internet protocol phone module according to the corresponding key pulse signal produced by the rectangular circuit due to the pressing against the plurality of number, arrow and function keys, the connecting/disconnecting key, and the plurality of operator keys.

6. The keypad of claim 2, wherein if the keypad is in an internet protocol phone operation mode, the internet protocol phone module is able to receive the corresponding key pulse signal produced by the rectangular circuit due to the pressing against the addition operation key, to produce a corresponding dialing signal according to the key pulse signal, and to transmit the dialing signal to the audio emitter so that the audio emitter is capable of increasing its volume according to the dialing signal.

7. The keypad of claim 2, wherein if the keypad is in an internet protocol phone operation mode, the internet protocol phone module is able to receive the corresponding key pulse signal produced by the rectangular circuit due to the pressing against the subtraction operation key, to produce a corresponding dialing signal according to the key pulse signal, and to transmit the corresponding dialing signal to the audio emitter so that the audio emitter is capable of decreasing its volume according to the dialing signal.

8. The keypad of claim 2, wherein if the keypad is in an internet operation mode, the internet protocol phone module is able to receive the key pulse signal produced by the rectangular circuit due to the pressing against the plurality of number, arrow and function keys, to produce a corresponding dialing signal according to the key pulse signal for forming a telephone number set by sufficient accumulation of the dialing signal, and to make a phone call to a remote receiver according to the telephone number set.

9. The keypad of claim 2, wherein if the control unit receives an internet protocol phone signal sent by the connecting port when the keypad is in an off-line status, a notifying signal will be produced by the control unit according to the internet protocol phone signal, then be transmitted to the codec for decoding, and thereafter transmitted to the audio emitter for producing a ring sound.

10. The keypad of claim 9, wherein the ring sound is produced by the audio emitter, and after the connecting/disconnecting key is pressed, the internet protocol phone module is enabled to produce a corresponding dialing signal according to the key pulse signal produced by the rectangular circuit so that the internet protocol phone module can process the subsequent internet protocol phone signal and use the audio emitter and audio receiver for communication.

11. The keypad of claim 1, wherein a monitor is mounted on a readily observing position of the housing, the monitor is connected to the control unit so that the display signal produced by the control unit is transmitted to the monitor for showing a corresponding display on the monitor according to the display signal.

12. The keypad of claim 11, wherein the control unit can analyze an internet protocol phone signal by using the internet protocol phone module for acquiring a source data of a calling party, the control unit can produce the corresponding display signal according to the source data, and the display signal is then transmitted to the monitor for showing the corresponding display on the monitor according to the display signal.

13. The keypad of claim 1, wherein the housing further comprises another connector for connecting to an external transceiver, the codec, and the control unit, and the another connector, in a status of connecting to the external transceiver, can emit a connecting signal to the control unit so that the control unit is enabled to transmit a stop signal to the audio emitter and the audio receiver for stopping the operation of the audio emitter and the audio receiver to produce and receive the sound through the external transceiver merely.

14. The keypad of claim 11, wherein the control unit further comprises a calculator module for producing the switch signal by pressing a mode switch key so that the keypad can be switched between the symbol input operation mode, an internet protocol phone operation mode, or a calculator operation mode by the control unit to enable the on-key pulse signal produced subsequently by the rectangular circuit to be transmitted to the control unit, keyboard module, internet protocol phone module respectively according to the present operation mode for performing the subsequent processing.

15. The keypad of claim 14, wherein the calculator module can receive the corresponding key pulse signal produced by the rectangular circuit due to the pressing against the number, arrow, and function keys, produce a corresponding calculating signal according to the key pulse signal, and transmit the calculating signal to the control unit by which the corresponding display signal is produced according to the calculating signal and the display signal is then transmitted to the monitor for showing a corresponding display on the monitor according to the display signal.

16. The keypad of claim 15, wherein the key set further comprises a send key, after the send key is pressed, a key pulse signal produced by the rectangular circuit is transmitted to the calculator module so that a sending signal is produced by the calculator module for transmitting the display data shown on the monitor to the electronic equipment through the connecting port to perform the subsequent processing.

17. The keypad of claim 2, wherein a light emitting device is mounted on the housing, and a corresponding key pulse signal is transmitted by the rectangular circuit to the control unit after the number lock key is pressed so that a corresponding light emitting signal is produced by the control unit and then transmitted to the light emitting device for changing the light emitting status of the light emitting device.

18. The keypad of claim 14, wherein a first operation status display region and a second operation status display region are set on the monitor for showing different symbols to express the present operation mode of the keypad.

19. The keypad of claim 18, wherein after the mode switch key is pressed, the keypad can be switched between the symbol input operation mode, the internet protocol phone operation mode, and the calculator operation mode by the control unit according to the switch signal, and meanwhile a corresponding display signal is produced by the control unit according to the switch signal and then transmitted to the monitor for showing a corresponding image on the first operation status display region and the second operation status display region of the monitor.

20. The keypad of claim 2, wherein if the internet protocol phone module is proceeded, the connecting/disconnecting key must be continuously pressed for a period of time so that the rectangular circuit can transmit the key pulse signal continuously to the internet protocol phone module within a predetermined period of time, and the internet protocol phone module is therefore capable of producing a corresponding dialing signal to disconnect the subsequent internet protocol phone signal for stopping the communication.

21. The keypad of claim 3, wherein when the keypad is in the internet protocol phone mode, the keypad can be restored automatically from the internet protocol phone mode to the last operation mode by the control unit, if the control unit does not receive the key pulse signal transmitted by the rectangular within a period of time.
